(19) United States
(12) Patent Application Publication
(10) Pub. No.: US 2026/0099182 A1
(43) Pub. Date: Apr. 9, 2026

(54) INFORMATION PROCESSING SYSTEM, POWER SUPPLY DEVICE, INFORMATION PROCESSING APPARATUS, AND CONTROL METHOD

(71) Applicant: Lenovo (Singapore) Pte. Ltd., Singapore (SG)

(72) Inventors: Munefumi Nakata, Kanagawa (JP); Tsuneo Koyanagi, Kanagawa (JP); Kousuke Tada, Kanagawa (JP)

(73) Assignee: Lenovo (Singapore) Pte. Ltd., Singapore (SG)

(21) Appl. No.: 19/350,440

(22) Filed: Oct. 6, 2025

(30) Foreign Application Priority Data
Oct. 4, 2024 (JP) 2024-175085

(51) Int. Cl. G06F 1/26; G06F 1/30; H02M 7/04

(52) U.S. Cl. CPC G06F 1/263; G06F 1/305; H02M 7/04

(57) ABSTRACT

An information processing system includes an information processing apparatus, and a power supply device which supplies, to the information processing apparatus, DC power converted from AC power. The power supply device includes a power supply unit which converts AC power to DC power and outputs the DC power, a power status detection unit which detects the status of the AC power, and a power information control unit which transmits, to the information processing apparatus, power information based on the detection result by the power status detection unit. The information processing apparatus includes a power supply unit which generates power to be consumed by loads within the information processing apparatus based on the DC power supplied from the power supply device, and a control unit which controls the power to be consumed by the loads within the information processing apparatus based on the power information transmitted from the power supply device.

### CROSS-REFERENCE TO RELATED APPLICATIONS

This application claims priority to Japanese Patent Application No. 2024-175085 filed on October 4, 2024, the contents of which are hereby incorporated herein by reference in their entirety.

### TECHNICAL FIELD

One or more embodiments of the present invention relate to an information processing system, a power supply device, an information processing apparatus, and a control method.

### BACKGROUND

A portable information processing apparatus such as a laptop-type or tablet-type personal computer is generally equipped with a battery to be able to charge the battery with power supplied from an AC adapter by connecting the AC adapter, and to generate a system power supply and supply power to each load within the information processing apparatus in order to operate the information processing apparatus (for example, see Japanese Unexamined Patent Application Publication No. 2003-295980).

Incidentally, the AC power supply may become unstable due to power restrictions depending on the location like inside an airplane or on a railway. Conventionally, in an environment with an unstable power supply, there is a measure being taken to ensure stable operation by reducing power consumption on the side of the information processing apparatus. For example, when the disconnection of the power supply from the AC adapter is detected multiple times within a predetermined time, the information processing apparatus performs control to reduce power consumption to stabilize operation.

However, in the conventional method of detecting the disconnection of the power supply from the AC adapter on the side of the information processing apparatus, since a case of the disconnection of the power supply on the side of an AC outlet (on the input side of the AC adapter) and a case where the connection between the AC adapter and the information processing apparatus is detached are detected as similar events (phenomena), both cases are indistinguishable. Therefore, for example, when a user plugs and unplugs the AC adapter into and from the information processing apparatus multiple times, there is a concern that power consumption may be reduced unnecessarily because it is erroneously detected that the AC power supply is in an unstable state.

### SUMMARY

Embodiments of the present disclosure provide an information processing system, a power supply device, an information processing apparatus, and a control method capable of properly detecting whether or not a power supply is being used in an unstable location to operate the information processing apparatus stably.

An information processing system according to the first aspect of the present invention includes an information processing apparatus, and a power supply device to supply, to the information processing apparatus, DC power converted from AC power, wherein the power supply device includes: a power supply unit which converts the AC power to the DC power and outputs the DC power; a power status detection unit which detects the status of the AC power; and a power information control unit which transmits, to the information processing apparatus, power information based on the detection result by the power status detection unit, and the information processing apparatus includes: a power supply unit which generates power to be consumed by loads within the information processing apparatus based on the DC power supplied from the power supply device; and a control unit which controls the power to be consumed by the loads within the information processing apparatus based on the power information transmitted from the power supply device.

The above information processing system may be such that, in the power supply device, the power information control unit transmits, to the information processing apparatus, information indicative of suppliable power as the power information based on the detection result by the power status detection unit.

The above information processing system may also be such that, in the power supply device, the power status detection unit detects a voltage fluctuation of the AC power, and the power information control unit changes the suppliable power from an initial value based on the detection result of the voltage fluctuation of the AC power by the power status detection unit.

The above information processing system may further be such that, in the power supply device, the power status detection unit detects a frequency of the AC power, and the power information control unit changes the suppliable power from an initial value based on the detection result of the frequency of the AC power by the power status detection unit.

Further, the above information processing system may be such that, in the power supply device, the power information control unit sets the suppliable power to the initial value when the connection between the power supply device and the information processing apparatus is cut off.

Further, the above information processing system may be such that, in the information processing apparatus, the control unit controls power to be consumed by the loads within the information processing apparatus using, as the upper limit, the suppliable power indicated in the power information transmitted from the power supply device.

Further, the above information processing system may be such that the power supply device further includes a backup power supply as a substitute for supplying power when power cannot be supplied to the power status detection unit and the power information control unit due to the voltage fluctuation of the AC power.

Further, the above information processing system may be such that, in the power supply device, when it is determined that the AC power becomes unstable based on the detection result by the power status detection unit, the power information control unit transmits the power information to the information processing apparatus.

Further, the above information processing system may be such that, in the power supply device, the power status detection unit detects the voltage fluctuation of the AC power, and when it is determined that the AC power becomes unstable based on the detection result of the voltage fluctuation of the AC power by the power status detection unit, the power information control unit transmits the power information to the information processing apparatus.

Further, the above information processing system may be such that, in the information processing apparatus, the control unit controls the upper limit of power to be consumed by loads within the information processing apparatus based on the power information transmitted from the power supply device.

Further, a power supply device according to the second aspect of the present invention is a power supply device which supplies, to an information processing apparatus, DC power converted from AC power, the power supply device including; a power supply unit which converts the AC power to the DC power and outputs the DC power; a power status detection unit which detects the status of the AC power; and a power information control unit which transmits, to the information processing apparatus, power information indicative of suppliable power based on the detection result by the power status detection unit.

Further, a power supply device according to the third aspect of the present invention is a power supply device which supplies, to an information processing apparatus, DC power converted from AC power, the power supply device including: a power supply unit which converts the AC power to the DC power and outputs the DC power; a power status detection unit which detects the status of the AC power; and a power information control unit which transmits, to the information processing apparatus, power information based on a determination result when it is determined that the AC power becomes unstable based on the detection result by the power status detection unit.

Further, an information processing apparatus according to the fourth aspect of the present invention is an information processing apparatus which receives, from a power supply device, the supply of DC power converted from AC power, the information processing apparatus including: a power supply unit which generates power to be consumed by loads within the information processing apparatus based on the DC power supplied from the power supply device; and a control unit which acquires, from the power supply device, power information based on a detection result of the status of the AC power, and controls an upper limit of the power to be consumed by the loads within the information processing apparatus based on the acquired power information.

Further, a control method according to the fifth aspect of the present invention is a control method in an information processing system including an information processing apparatus and a power supply device to supply, to the information processing apparatus, DC power converted from AC power, the control method including: a step of causing the power supply device to convert the AC power to the DC power and output the DC power; a step of causing the power supply device to detect the status of the AC power; a step of causing the power supply device to transmit, to the information processing apparatus, power information based on the detection result of the status of the AC power; a step of causing the information processing apparatus to generate power to be consumed by loads within the information processing apparatus based on the DC power supplied from the power supply device; a step of causing the information processing apparatus to acquire the power information transmitted from the power supply device; and a step of causing the information processing apparatus to control the power to be consumed by the loads within the information processing apparatus based on the acquired power information.

Further, a control method according to the sixth aspect of the present invention is a control method in a power supply device which supplies, to an information processing apparatus, DC power converted from AC power, the control method including: a step of causing a power supply unit to convert the AC power to the DC power and to output the DC power; a step of causing a power status detection unit to detect the status of the AC power; and a step of causing a power information control unit to transmit, to the information processing apparatus, power information indicative of suppliable power based on the detection result by the power status detection unit.

Further, a control method according to the seventh aspect of the present invention is a control method in a power supply device which supplies, to an information processing apparatus, DC power converted from AC power, the control method including: a step of causing a power supply unit to convert the AC power to the DC power and to output the DC power; a step of causing a power status detection unit to detect the status of the AC power; and a step in which, when it is determined that the AC power becomes unstable based on the detection result by the power status detection unit, a power information control unit transmits, to the information processing apparatus, power information based on the determination result.

Further, a control method according to the eighth aspect of the present invention is a control method in an information processing apparatus which receives, from a power supply device, the supply of DC power converted from AC power, the control method including: a step of causing a power supply unit to generate power to be consumed by loads within the information processing apparatus based on the DC power supplied from the power supply device; a step of causing a control unit to acquire, from the power supply device, power information based on a detection result of the status of the AC power; and a step of causing the control unit to control an upper limit of the power to be consumed by the loads within the information processing apparatus based on the acquired power information.

One or more embodiments of the present invention can properly detect whether or not the power supply is being used in an unstable location to operate the information processing apparatus stably.

### BRIEF DESCRIPTION OF THE DRAWINGS

FIG. 1 is a system diagram illustrating an example of the configuration of an information processing system according to one or more embodiments.

FIG. 2 is a diagram illustrating an overview of output power control according to one or more embodiments.

FIG. 3 is a schematic block diagram illustrating an example of the configuration of an information processing apparatus according to one or more embodiments.

FIG. 4 is a schematic block diagram illustrating an example of the configuration of an AC adapter according to one or more embodiments.

FIG. 5 is a flowchart illustrating an example of output power control processing according to one or more embodiments.

FIG. 6 is a flowchart illustrating another example of output power control processing according to one or more embodiments.

FIG. 7 is a schematic block diagram illustrating an example of the information processing apparatus and an AC adapter according to one or more embodiments.

FIG. 8 is a flowchart illustrating an example of power control processing according to one or more embodiments.

### DETAILED DESCRIPTION

Embodiments of the present invention will be described with reference to the accompanying drawings.

### First Embodiment

First, a first embodiment of the present invention will be described.

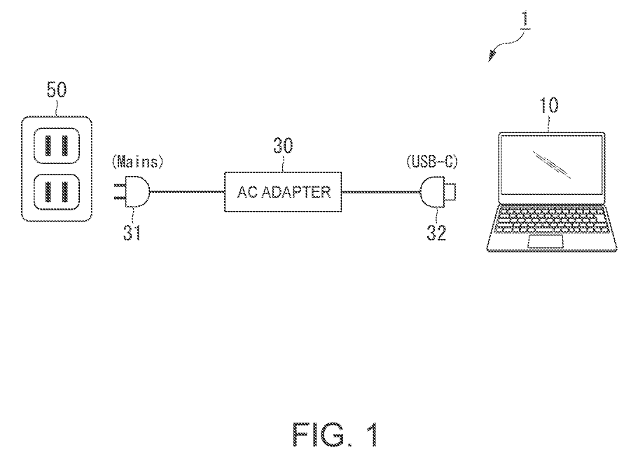

FIG. 1 is a system diagram illustrating an example of an information processing system according to one or more embodiments.

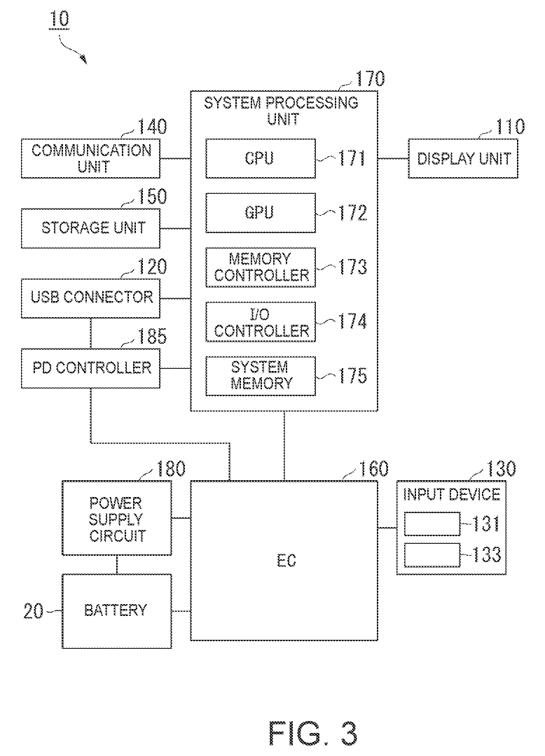

An illustrated information processing system 1 includes an information processing apparatus 10 and an AC adapter 30. The information processing apparatus 10 is, for example, a clamshell-type (laptop-type) PC (Personal Computer). Note that the information processing apparatus 10 may also be a tablet-type PC, a smartphone, or the like. The information processing apparatus 10 is internally equipped with a battery 20 (see FIG. 3).

The AC adapter 30 (an example of a power supply device) is such that a plug 31 for being inserted into an input-side outlet is connected to an AC outlet 50 (a main power supply), and an output-side connector 32 is connected to the information processing apparatus 10. The connector 32 is, for example, a USB (Universal Serial Bus) 3.1 compatible USB-C (USB Type-C) connector (plug side).

From the AC outlet 50, power (AC power) of a commercial AC (Alternate Current) power supply is supplied. The AC adapter 30 converts AC power supplied from the AC outlet 50 into power (DC power) of a DC (Direct Current) power supply to supply the DC power to the information processing apparatus 10.

The information processing apparatus 10 generates power to be consumed by loads within the information processing apparatus 10 based on the DC power supplied from the AC adapter 30. The loads within the information processing apparatus 10 includes a load that consumes the power in each unit (a system, a display, a camera, or the like) equipped in the information processing apparatus 10, a load that consumes the power for charging the battery 20 (see FIG. 3), and the like.

Here, the AC power supply may become unstable due to power restrictions depending on the location like inside an airplane or on a railway. For example, power (hereinafter called “output power”) that can be supplied from an AC power supply, which is provided in a train, an airplane, or the like, is restricted to be lower than AC power from a normal AC power supply. Therefore, in the information processing system 1 according to one or more embodiments, the AC adapter 30 detects the status of the AC power on the input side (on the side of the AC power supply), and when detecting an unstable state, the AC adapter 30 changes information on output power to be notified from the AC adapter 30 to the side of the information processing apparatus 10. Thus, the power used in the information processing apparatus 10 is dynamically changed.

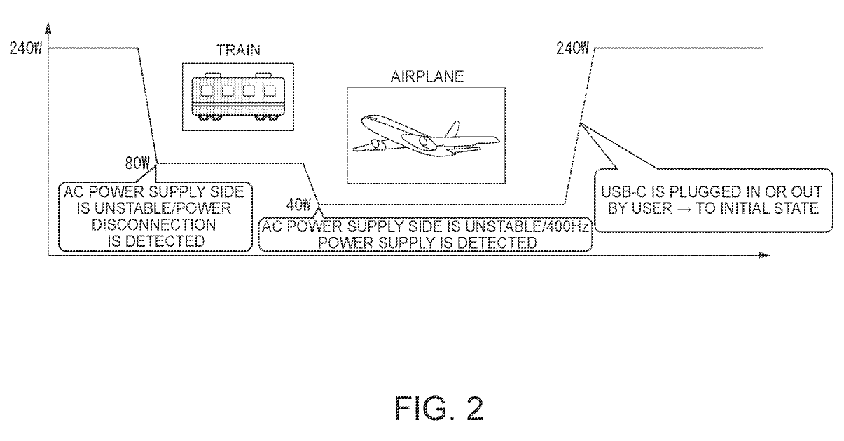

FIG. 2 is a diagram illustrating an overview of output power control according to one or more embodiments. When the information processing apparatus 10 is operated with initial output power (for example, 240 W), AC power on the AC power supply side may become unstable due to restrictions on output power of an AC power supply, for example, in a train (because of low output power). For example, when detecting the disconnection of the AC power multiple times within a predetermined time, the AC adapter 30 detects that the AC power is unstable, and changes the output power to a smaller value (for example, 80 W) to be notified to the information processing apparatus 10. Thus, the information processing apparatus 10 can be operated stably, for example, in the train by reducing power consumption according to this notified output power value.

Further, even in the state where the output power is changed to the smaller value (for example, 80 W) described above, the AC power on the AC power supply side may become unstable, for example, in an airplane due to the restrictions on the output power more than the AC power in the train (because of the lower output power). For example, when detecting the disconnection of the AC power multiple times within the predetermined time even in such a state that the output power is changed to the smaller value (for example, 80 W), the AC adapter 30 detects that the AC power is unstable, and changes the output power to further smaller value (for example, 40 W). Thus, the information processing apparatus 10 can be operated stably, for example, in the airplane by reducing power consumption according to this notified output power value.

Note that the frequency of the AC power supply inside the airplane is a specific frequency (for example, 400 Hz) different from those in other locations. Therefore, when detecting that the frequency of the AC power supply is the specific frequency (for example, 400 Hz), the AC adapter 30 may also change the output power to a smaller value (for example, 40 W) even without detecting the disconnection of the AC power multiple times within the predetermined time.

Note that when the connector 32 (USB-C) is unplugged by a user, the AC adapter 30 detects that the connection with the information processing apparatus 10 is cut off, and returns to the initial output power (for example, 240 W).

The configuration of the information processing system 1 according to one or more embodiments will be described in detail below.

### Configuration of Information Processing Apparatus

FIG. 3 is a schematic block diagram illustrating an example of the configuration of the information processing apparatus 10 according to one or more embodiments. The information processing apparatus 10 is configured to include a display unit 110, a USB connector 120, an input device 130, a communication unit 140, a storage unit 150, an EC (Embedded Controller) 160, a system processing unit 170, a power supply circuit 180, and a PD controller 185.

The display unit 110 is configured to include an LCD (Liquid Crystal Display) or an EL (Electro Luminescence) display, and the like. The display unit 110 displays images based on display data generated by system processing executed by the system processing unit 170.

The USB connector 120 is a connector for connecting peripheral devices using USB. For example, the USB connector 120 is a USB-C connector. By connecting the AC adapter 30 to the USB connector 120, DC power can be supplied from the AC adapter 30. Note that the information processing apparatus 10 may further include a USB-A (USB Type-A) connector as the USB connector 120.

The input device 130 is an input unit for accepting user input, which is configured to include, for example, a keyboard 131 and a touchpad 133. The input device 130 outputs, to the EC 160, an operation signal indicative of operation details in response to accepting operations on the keyboard 131 and the touchpad 133.

The communication unit 140 connects to other devices communicably through wireless or wired communication networks to transmit and receive various data. For example, the communication unit 140 is configured to include communication devices such as a wired LAN interface such as Ethernet (registered trademark), a wireless LAN interface such as Wi-Fi (registered trademark), and the like. Note that the communication unit 140 may also be configured to include a USB (Universal Serial Bus) interface and a Bluetooth (registered trademark) interface.

The storage unit 150 is configured to include storage media such as an HDD (Hard Disk Drive) or an SSD (Solid State Drive), a RAM (Random Access Memory), a ROM (Read Only Memory), and the like. The HDD or the SSD stores an OS, various programs such as device drivers and applications, and various data acquired by operating the programs.

The EC 160 is a microcomputer configured to include a CPU, a RAM, a ROM, an I/O(Input/Output) logic circuit, and the like. The CPU of the EC 160 reads a control program prestored in the own ROM, and executes the read control program to fulfill the functionality. For example, the EC 160 operates independently of the system processing unit 170 to give system operating state transition instructions (bootup, transition to a standby state, and the like) to the system processing unit 170 and to manage the operating states.

Further, the EC 160 is connected to the input device 130, the power supply circuit 180, the PD controller 185, and the like. Based on operation information input to the input device 130 according to user operations, the EC 160 transmits the operation information according to the operations to the system processing unit 170 and the like. Further, the EC 160 communicates with the power supply circuit 180 to acquire information on the state of the battery 20 (remaining capacity, voltage, and the like) from the power supply circuit 180 and to perform charging control when the power supply circuit 180 charges the battery 20 using power supplied from the AC adapter 30. Further, the EC 160 outputs, to the power supply circuit 180, a control signal or the like to control the supply of system power according to the system operating state. Further, the EC 160 controls power to be consumed by loads within the information processing apparatus 10 based on information acquired from the AC adapter 30 through the PD controller 185.

The power supply circuit 180 generates power to be supplied to each unit of the information processing apparatus 10 based on the DC power supplied from the AC adapter 30. Further, the power supply circuit 180 is equipped with a charging circuit to generate charging power to be supplied to the battery 20 based on the DC power supplied from the AC adapter 30. In other words, the power supply circuit 180 generates power to be consumed by the loads within the information processing apparatus 10 based on the DC power supplied from the AC adapter 30. Further, when the AC adapter 30 is not connected, the power supply circuit 180 generates power to be supplied to each unit of the information processing apparatus 10 based on the DC power supplied from the battery 20. For example, the power supply circuit 180 includes a DC/DC converter and the like to convert the voltage of the power supplied from the AC adapter 30 or the battery 20 into a specified voltage in order to generate power to be supplied to each unit such as the system processing unit 170, the display unit 110, the communication unit 140, the storage unit 150, the PD controller 185, or the like.

The PD controller 185 executes control compatible with USB PD (Power Delivery). When the AC adapter 30 is connected, the PD controller 185 manages an external power supply function powered through a VBUS (power line) of the USB. For example, the PD controller 185 monitors a VBUS terminal and a CC signal line to determine whether or not the AC adapter 30 is connected to the USB connector 120. Further, the PD controller 185 communicates various information with the AC adapter 30 through the CC signal line of the USB.

The system processing unit 170 is configured to include a CPU 171, a GPU (Graphics Processing Unit) 172, a memory controller 173, an I/O (Input-Output) controller 174, and a system memory 175, where various application software processing is executable on an operating system (OS) by OS system processing. The CPU 171 and the GPU 172 may be collectively referred to as a processor.

The CPU 171 controls the system operating state, such as system bootup, transition to a standby state (sleep), or the like, based on instruction information from the EC 160. For example, when the system operating state is the standby state and instruction information on an instruction of bootup is input from the EC 160 according to a user operation, the CPU 171 makes a transition from the standby state to a normal operating state. For example, upon bootup, when the supply of power is received from the power supply circuit 180 and instruction information to instruct bootup is input from the EC 160, the CPU 171 starts bootup processing. In the bootup processing, the CPU 171 performs detection and initialization of a minimum number of devices such as the system memory 175 and the storage unit 150 (pre-boot). The CPU 171 loads system firmware from the storage unit 150 into the system memory 175, and performs detection and initialization of the other devices such as the communication unit 140 and the display unit 110 (post-processing). In the initialization, processes such as initial parameter settings and the like are included. Note that part of the post-processing may be omitted in the transition from the standby state (sleep) to the normal operating state (resume). After the bootup processing is completed, the CPU 171 starts the execution of system processing by the OS.

The GPU 172 is connected to the display unit 110. The GPU 172 executes image processing under the control of the CPU 171 to generate display data. The GPU 172 outputs the generated display data to the display unit 110. Note that the CPU 171 and the GPU 172 may be integrated and formed as one core, or mutual load may be shared between the CPU 171 and the GPU 172 formed as individual cores. The number of processors is not limited to one, which may be two or more.

The memory controller 173 controls reading data from and writing data to the system memory 175, the storage unit 150, and the like by the CPU 171 and the GPU 172.

The I/O controller 174 controls input/output of data from the communication unit 140, the display unit 110, and the EC 160.

The system memory 175 is used as a reading area of execution programs of the processor(s) and a working area to write processed data.

Here, the system processing unit 170 has an operating mode for reducing power consumption. For example, power consumption can be reduced by lowering an operating frequency of the CPU 171 or by stopping part of processing being executed by the CPU 171 (for example, background processing or the like). The power consumption can also be reduced by reducing the screen brightness of the display unit 110 or by restricting the communication function by the communication unit 140 (stop or intermittent operation). In these reductions in power consumption, multiple stages may be provided depending on the amount of reduction, which are also controlled, for example, by instructions from the EC 160.

For example, based on information acquired from the AC adapter 30, the EC 160 performs control to reduce power to be consumed by the loads within the information processing apparatus 10, and the like. As an example, the information acquired from the AC adapter 30 is information on output power indicative of power suppliable from the AC adapter 30 to the information processing apparatus 10.

### Configuration of AC Adapter

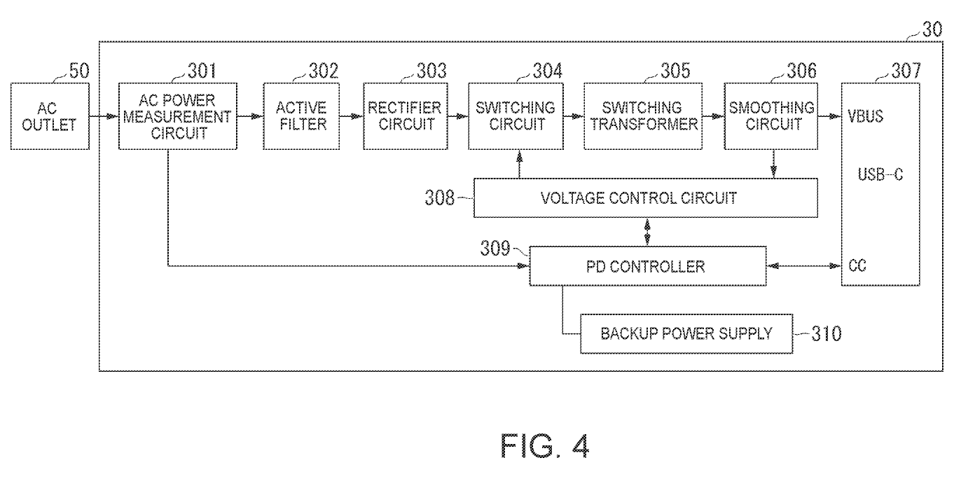

Referring next to FIG. 4, a configuration in which the AC adapter 30 transmits the information on the output power to the information processing apparatus 10 will be described. FIG. 4 is a schematic block diagram illustrating the configuration of the AC adapter 30 according to one or more embodiments.

The AC adapter 30 includes an AC power measurement circuit 301, an active filter 302, a rectifier circuit 303, a switching circuit 304, a switching transformer 305, a smoothing circuit 306, a USB-C interface 307, a voltage control circuit 308, a PD controller 309, and a backup power supply 310.

AC power is supplied from the AC outlet 50 to the AC adapter 30 by inserting the plug 31 into the AC outlet 50. First, the AC power measurement circuit 301 detects the status of the AC power (AC power supply) supplied from the AC outlet 50. For example, the AC power measurement circuit 301 measures the voltage of the AC power supplied from the AC outlet 50 to detect a voltage fluctuation of the AC power. Further, the AC power measurement circuit 301 measures and detects the frequency of the AC power supplied from the AC outlet 50. Then, the AC power measurement circuit 301 transmits, to the PD controller 309, information indicative of the voltage fluctuation or the frequency of the AC power as information indicative of the detection result of the AC power status.

Further, the AC power supplied from the AC outlet 50 is output as DC power through the active filter 302, the rectifier circuit 303, the switching circuit 304, the switching transformer 305, the smoothing circuit 306, and the USB-C interface 307. The voltage control circuit 308 detects the output voltage of the DC power and performs feedback control on the switching circuit 304 so that the detected output voltage becomes a target voltage. The DC power output from the USB-C interface 307 is supplied to the information processing apparatus 10 connected to the connector 32 via a USB cable.

The PD controller 309 executes control compatible with USB PD (Power Delivery). The PD controller 309 is connected to the AC power measurement circuit 301, the USB-C interface 307, and the voltage control circuit 308. The PD controller 309 communicates various information related to power supply with the PD controller 185 on the side of the information processing apparatus 10 through the CC signal line of the USB.

For example, the PD controller 309 acquires information indicative of the detection result of the AC power status from the AC power measurement circuit 301. Then, based on the detection result of the AC power status, the PD controller 309 transmits, to the information processing apparatus 10, information (PDO: Power Data Object) on the output power suppliable from the AC adapter 30.

Specifically, for example, as described with reference to FIG. 2, when the disconnection of the AC power is detected multiple times within the predetermined time based on the voltage fluctuation of the AC power detected by the AC power measurement circuit 301, the PD controller 309 changes the output power information (PDO) to a smaller value (for example, to 80 W or 40 W) and transmits the changed output power information (PDO) to the information processing apparatus 10. Further, for example, when the frequency is detected to be the specific frequency (for example, 400 Hz) based on the frequency of the AC power detected by the AC power measurement circuit 301, the PD controller 309 changes the output power information (PDO) to a smaller value (for example, to 40 W) and transmits the changed output power information (PDO) to the information processing apparatus 10. Further, for example, when it is detected that the AC adapter 30 and the information processing apparatus 10 are disconnected (the connection is cut off), the PD controller 309 sets the output power to an initial value (for example, to 240 W).

In the information processing apparatus 10, the EC 160 acquires this output power information (PDO) from the AC adapter 30 through the PD controller 185. The EC 160 controls power to be consumed by the loads within the information processing apparatus 10 using, as an upper limit, power suppliable by the AC adapter 30 indicated in this output power information (PDO). For example, when the value of the power suppliable by the AC adapter 30 is changed to a value smaller than the initial value, the EC 160 reduces the power to be consumed by the loads within the information processing apparatus 10 to operate the information processing apparatus 10 stably.

For example, when reducing power consumption, the EC 160 lowers the operating frequency of the CPU 171 or stops part of processing being executed by the CPU 171 (for example, background processing or the like). Further, the EC 160 reduces power consumption by reducing the screen brightness of the display unit 110 or by restricting the communication function by the communication unit 140 (stop or intermittent operation). As an example, based on the output power information (PDO) acquired from the AC adapter 30, the EC 160 may also select a suitable operating mode from among multiple operating modes provided in stages depending on the amount of reduction in power consumption.

Further, the backup power supply 310 included in the AC adapter 30 is provided as a substitute when power cannot be supplied to the AC power measurement circuit 301 and the PD controller 309 due to the voltage fluctuation of the AC power. Thus, when the disconnection of the AC power is detected multiple times within the predetermined time, the AC adapter 30 can change the output power information (PDO) and transmit the changed output power information (PDO) to the information processing apparatus 10.

The backup power supply 310 is, for example, a large-capacitance capacitor (a super capacitor). Note that the backup power supply 310 may also be a secondary battery.

### Operation of Output Power Control Processing

Next, the operation of output power control processing to control the output power information (PDO) to be transmitted by the AC adapter 30 to the information processing apparatus 10 based on the detection result of the AC power status will be described.

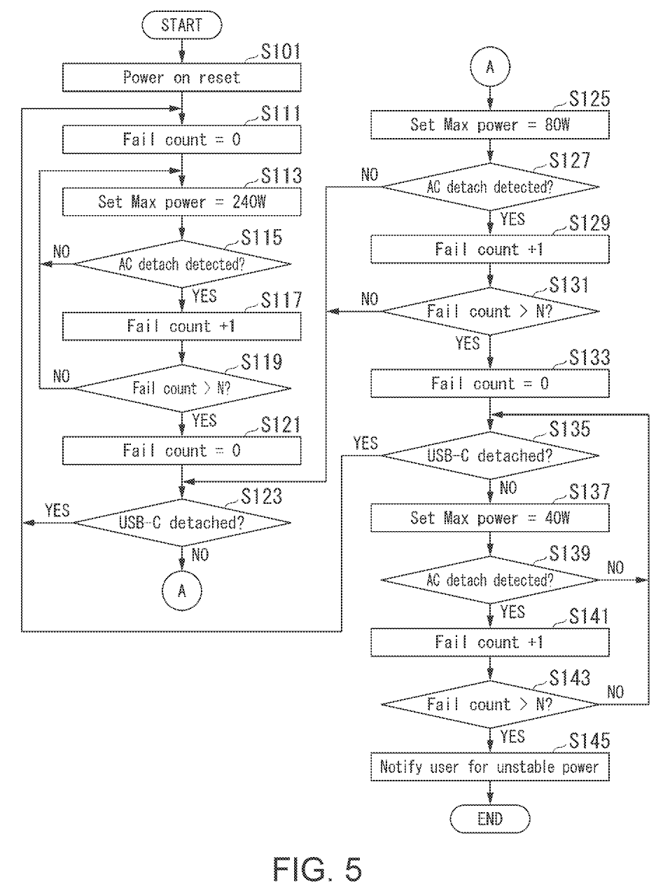

FIG. 5 is a flowchart illustrating an example of output power control processing according to one or more embodiments. Here, for example, it is assumed that the information processing apparatus 10 and the AC adapter 30 are in the connected state.

(Step S101) When the plug 31 of the AC adapter 30 is inserted into the AC outlet 50, the supply of the AC power from the AC outlet 50 to the AC adapter 30 is started, and the circuits in the AC adapter 30 are reset (Power on reset). Then, the procedure proceeds to a process in step S111.

(Step S111) The PD controller 309 sets a counter value (Fail count) to 0, and proceeds to a process in step S113.

(Step S113) The PD controller 309 sets suppliable output power to an initial value (for example, to 240 W), (Set Max power = 240 W), and transmits the set output power information (PDO) to the information processing apparatus 10. Then, the PD controller 309 proceeds to a process in step S115.

(Step S115) The PD controller 309 determines whether or not the disconnection of the AC power has occurred based on the detection result of the AC power status by the AC power measurement circuit 301. When determining that the disconnection of the AC power has not occurred (NO), the PD controller 309 returns to the process in step S113. On the other hand, when determining that the disconnection of the AC power supply has occurred (YES), the PD controller 309 proceeds to a process in step S117.

(Step S117) The PD controller 309 adds 1 to the counter value (Fail count), and proceeds to a process in step S119.

(Step S119) The PD controller 309 determines whether or not the number of times the disconnection of the AC power has occurred exceeds N times within the predetermined time. Specifically, the PD controller 309 determines whether or not the counter value (Fail count) exceeds N. Here, any positive integer can be set as N. When the counter value (Fail count) is N or less (NO), the PD controller 309 returns to the process in step S113. On the other hand, when the counter value (Fail count) exceeds N (YES), the PD controller 309 proceeds to a process in step S121. For example, in the case of N = 4, when the disconnection of the AC power is detected five times within the predetermined time, the PD controller 309 proceeds to the process in step S121. Note that the predetermined time can be determined arbitrarily. For example, the predetermined time may be set to five minutes or the like.

(Step S121) The PD controller 309 resets the counter value (Fail count) to 0, and proceeds to a process in step S123.

(Step S123) The PD controller 309 determines whether or not the connection with the information processing apparatus 10 is lost (the connection is cut off). For example, when the connector 32 is unplugged by the user from the information processing apparatus 10, the PD controller 309 determines that the connection with the information processing apparatus 10 is lost (the connection is cut off) (YES), and returns to the process in step S111. On the other hand, when determining that the connection with the information processing apparatus 10 is not lost (the connection is not cut off) (NO), the PD controller 309 proceeds to a process in step S125.

(Step S125) The PD controller 309 changes the suppliable output power to a value smaller than the initial value (for example, 80 W) (Set Max power = 80 W), and transmits the changed output power information (PDO) to the information processing apparatus 10. Then, the PD controller 309 proceeds to a process in step S127.

(Step S127) Based on the detection result of the AC power status by the AC power measurement circuit 301, the PD controller 309 determines whether or not the disconnection of the AC power has occurred. When determining that the disconnection of the AC power has not occurred (NO), the PD controller 309 returns to the process in step S123. On the other hand, when determining that the disconnection of the AC power has occurred (YES), the PD controller 309 proceeds to a process in step S129.

(Step S129) The PD controller 309 adds 1 to the counter value (Fail count), and proceeds to a process in step S131.

(Step S131) The PD controller 309 determines whether or not the number of times the disconnection of the AC power has occurred exceeds N times within the predetermined time. Specifically, the PD controller 309 determines whether or not the counter value (Fail count) exceeds N. Here, any positive integer can be set as N. When the counter value (Fail count) is N or less (NO), the PD controller 309 returns to the process in step S123. On the other hand, when the counter value (Fail count) exceeds N (YES), the PD controller 309 proceeds to a process in step S133. For example, in the case of N = 4, when the disconnection of the AC power is detected five times within the predetermined time, the PD controller 309 proceeds to the process in step S133. Note that N may be the same value as that in step S119 or may be a different value. Further, the predetermined time can be determined arbitrarily, which may be the same value as that in step S119, or may be a different value.

(Step S133) The PD controller 309 resets the counter value (Fail count) to 0, and proceeds to a process in step S135.

(Step S135) The PD controller 309 determines whether or not the connection with the information processing apparatus 10 is lost (the connection is cut off). For example, when the connector 32 is unplugged by the user from the information processing apparatus 10, the PD controller 309 determines that the connection with the information processing apparatus 10 is lost (the connection is cut off) (YES), and returns to the process in step S111. On the other hand, when determining that the connection with the information processing apparatus 10 is not lost (the connection is not cut off) (NO), the PD controller 309 proceeds to a process in step S137.

(Step S137) The PD controller 309 changes the suppliable output power to a further smaller value (for example, 40 W) (Set Max power = 40 W), and transmits the changed output power information (PDO) to the information processing apparatus 10. Then, the PD controller 309 proceeds to a process in step S139.

(Step S139) Based on the detection result of the AC power status by the AC power measurement circuit 301, the PD controller 309 determines whether or not the disconnection of the AC power has occurred. When determining that the disconnection of the AC power has not occurred (NO), the PD controller 309 returns to the process in step S135. On the other hand, when determining that the disconnection of the AC power has occurred (YES), the PD controller 309 proceeds to a process in step S141.

(Step S141) The PD controller 309 adds 1 to the counter value (Fail count), and proceeds to a process in step S143.

(Step S143) The PD controller 309 determines whether or not the number of times the disconnection of the AC power has occurred exceeds N times within the predetermined time. Specifically, the PD controller 309 determines whether or not the counter value (Fail count) exceeds N. Here, any positive integer can be set as N. When the counter value (Fail count) is N or less (NO), the PD controller 309 returns to the process in step S135. On the other hand, when the count value (Fail count) exceeds N (YES), the PD controller 309 proceeds to a process in step S145. For example, in the case of N = 4, when the disconnection of the AC power is detected five times within the predetermined time, the PD controller 309 proceeds to the process in step S145. Note that N may be the same value as that in step S119 or in step S131, or may be a different value. Further, the predetermined time can be determined arbitrarily, which may be the same value as that in step S119 or in step S131, or may be a different value.

(Step S145) Since power to be supplied is unstable even when the output power is a value set in step S137 (for example, 40 W) (that is, even when the upper limit of the power consumption of the information processing apparatus 10 is set to 40 W), the PD controller 309 notifies the user that the power is unstable. As the notification method, any method can be applied. For example, the notification may be done in a way that the PD controller 309 notifies the information processing apparatus 10 that the power is unstable, and the information processing apparatus 10 displays, on the display unit 110, that the power is unstable. In short, this state in step S145 means that the environment is not suitable for using the information processing apparatus 10.

Note that, when there is no disconnection of the AC power over the predetermined time (when the AC power is stable), the PD controller 309 resets the counter value (Fail count) to 0.

### Another Example of Operation of Output Power Control Processing

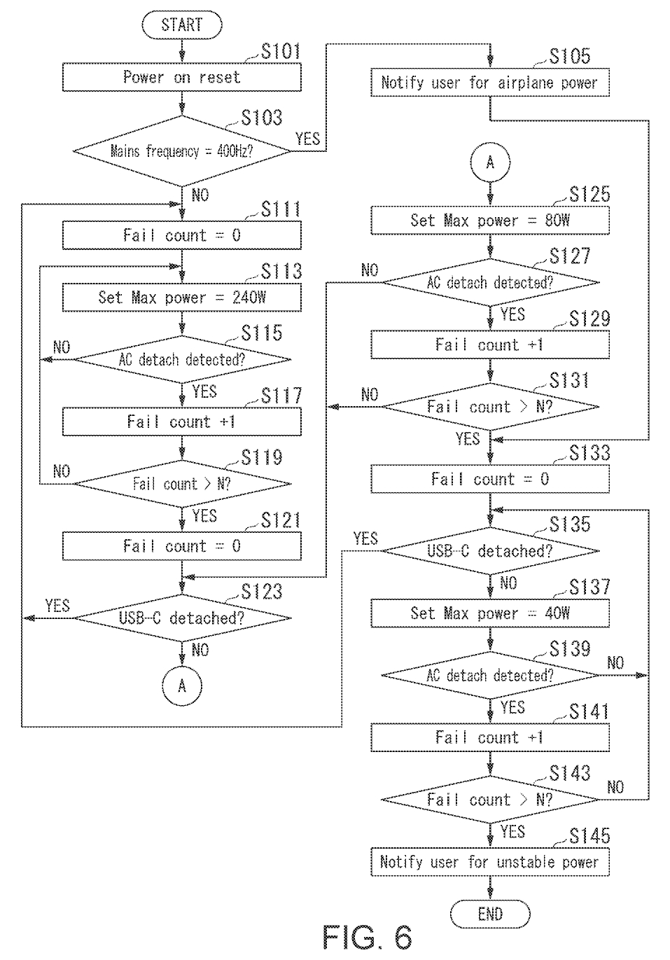

In the output power control processing illustrated in FIG. 5, the operation example in which the disconnection of the AC power (the state where the AC power is unstable) is detected to control the output power is given, but when the frequency of the AC power is detected to be the specific frequency (for example, 400 Hz) as described above, the location (for example, inside the airplane) can be identified and output power can be controlled. Therefore, another operation example in which processes of detecting the frequency of the AC power are added will be described with reference to FIG. 6.

FIG. 6 is a flowchart illustrating another example of output power control processing according to one or more embodiments. In FIG. 6, processes corresponding to respective processes in FIG. 5 are given the same step numbers, and the description thereof will be omitted. The output power control processing illustrated in FIG. 6 is different from the output power control processing illustrated in FIG. 5 in that processes in step S103 and S105 are added.

In step S101, the supply of the AC power from the AC outlet 50 to the AC adapter 30 is started and the circuits in the AC adapter 30 are reset (Power on reset). Then, the procedure proceeds to a process in step S103.

(Step S103) Based on the frequency of the AC power detected by the AC power measurement circuit 301, the PD controller 309 determines whether or not the frequency of the AC power supply (main power supply) is a specific frequency (for example, 400 Hz). When determining that the frequency of the AC power supply (main power supply) is not the specific frequency (for example, 400 Hz) (NO), the PD controller 309 proceeds to a process in step S111, and the same output power control processing as that in FIG. 5 is performed after that. On the other hand, when determining that the frequency of the AC power supply (main power supply) is the specific frequency (for example, 400 Hz) (YES), the PD controller 309 proceeds to a process in step S105.

(Step S105) The PD controller 309 notifies the user that the power supply is, for example, an airplane power supply. As the notification method, any method can be applied. For example, the notification may be done in a way that the PD controller 309 notifies the information processing apparatus 10 that the power supply is the airplane power supply, and the information processing apparatus 10 displays, on the display unit 110, that the power supply is the airplane power supply. Then, the PD controller 309 proceeds to the process in step S133. Thus, when detecting that the frequency of the AC power supply (main power supply) is an airplane-specific frequency (for example, 400 Hz), the PD controller 309 can change output power to an airplane output power value (for example, 40 W) instantly without performing the subsequent processes illustrated in FIG. 5 (Set Max power = 40 W), and can transmit the changed output power information (PDO) to the information processing apparatus 10.

As described above, the information processing system 1 according to one or more embodiments includes the information processing apparatus 10, and the AC adapter 30 (an example of a power supply device) to supply, to the information processing apparatus 10, DC power converted from AC power. The AC adapter 30 includes a power supply unit for converting AC power to DC power and outputting the DC power (for example, the active filter 302, the rectifier circuit 303, the switching circuit 304, the switching transformer 305, the smoothing circuit 306, the USB-C interface 307, and the voltage control circuit 308). Further, the AC adapter 30 includes the AC power measurement circuit 301 (an example of a power status detection unit) for detecting AC power status, and the PD controller 309 (an example of a power information control unit) for transmitting, to the information processing apparatus 10, power information (for example, output power information) based on the detection result by the AC power measurement circuit 301. The information processing apparatus 10 includes the power supply circuit 180 (an example of a power supply unit) for generating power to be consumed by the loads within the information processing apparatus 10 based on the DC power supplied from the AC adapter 30, and the EC 160 (an example of a control unit) for controlling the power to be consumed by the loads within the information processing apparatus 10 based on the power information (for example, the output power information) transmitted from the AC adapter 30.

Thus, in the information processing system 1, since the AC adapter 30 notifies the information processing apparatus 10 of the power information based on the detection result of the AC power status, and the information processing apparatus 10 controls power to be consumed by the loads within the information processing apparatus 10 based on the power information notified from the AC adapter 30, it can be properly detected whether or not the information processing apparatus 10 is being used in a location where the power supply is unstable to operate the information processing apparatus 10 stably.

For example, in the AC adapter 30, based on the detection result by the AC power measurement circuit 301, the PD controller 309 transmits, to the information processing apparatus 10, output power information indicative of suppliable power as the power information.

Thus, in the information processing system 1, since the AC adapter 30 notifies the information processing apparatus 10 of the output power information based on the detection result of the AC power status, the information processing apparatus 10 can reduce power to be consumed by the loads within the information processing apparatus 10 according to the suppliable power from the AC adapter 30. Therefore, the information processing system 1 can properly detect whether or not the information processing apparatus 10 is being used in the location where the power supply is unstable to operate the information processing apparatus 10 stably.

As an example, in the AC adapter 30, the AC power measurement circuit 301 detects a voltage fluctuation of AC power (for example, the disconnection of the AC power). Then, based on the detection result of the voltage fluctuation of the AC power by the AC power measurement circuit 301, the PD controller 309 changes the output power (suppliable power) from the initial value.

Thus, in the information processing system 1, since the AC adapter 30 notifies the information processing apparatus 10 of the output power information due to the fact that the voltage fluctuation of the AC power (for example, the disconnection of the AC power) has occurred, the information processing apparatus 10 can reduce power to be consumed by the loads within the information processing apparatus 10 according to the suppliable power from the AC adapter 30. Therefore, the information processing system 1 can properly detect whether or not the information processing apparatus 10 is being used in the location where the power supply is unstable to operate the information processing apparatus 10 stably.

In the AC adapter 30, the AC power measurement circuit 301 detects the frequency of AC power . Then, based on the detection result of the frequency of the AC power by the AC power measurement circuit 301, the PD controller 309 may also change the output power (suppliable power) from the initial value.

Thus, in the information processing system 1, when the frequency of the AC power is, for example, an airplane frequency, since the AC adapter 30 notifies the information processing apparatus 10 of information on airplane output power (output power lower than that of a common power supply), the information processing apparatus 10 can reduce power to be consumed by the loads within the information processing apparatus 10 according to the airplane output power. Therefore, the information processing system 1 can properly detect whether or not the information processing apparatus 10 is being used in a location where the power supply is unstable to operate the information processing apparatus 10 stably.

Further, when the connection between the AC adapter 30 and the information processing apparatus 10 is cut off, the PD controller 309 in the AC adapter 30 sets the output power (suppliable power) to the initial value.

Thus, once the AC adapter 30 is detached from the information processing apparatus 10, since the AC adapter 30 resets the output power information, changed output power information can be prevented from being applied unintentionally when used after that. For example, when the AC adapter 30 is next connected to the information processing apparatus 10, the information processing apparatus 10 can be prevented from being operated by reducing power consumption meaninglessly.

Further, in the information processing apparatus 10, the EC 160 controls power to be consumed by the loads within the information processing apparatus 10 using, as the upper limit, the output power (suppliable power) indicated in the power information (for example, the output power information) transmitted from the AC adapter 30.

Thus, since the information processing apparatus 10 controls power to be consumed by the loads within the information processing apparatus 10 using the power suppliable from the AC adapter 30 as the upper limit, the information processing apparatus 10 can be operated stably.

Further, the AC adapter 30 is equipped with the backup power supply 310 for supplying power as a substitute when power cannot be supplied to the AC power measurement circuit 301 and the PD controller 309 due to the voltage fluctuation of the AC power.

Thus, in the information processing system 1, the AC adapter 30 can properly detect that the voltage fluctuation of the AC power (for example, the disconnection of the AC power) has occurred, and can notify the information processing apparatus 10 of power information based on the detection result.

Further, the AC adapter 30 (the example of the power supply device) according to one or more embodiments supplies, to the information processing apparatus 10, DC power converted from the AC power. The AC adapter 30 includes the power supply unit for converting the AC power to the DC power and outputting the DC power (for example, the active filter 302, the rectifier circuit 303, the switching circuit 304, the switching transformer 305, the smoothing circuit 306, the USB-C interface 307, and the voltage control circuit 308). Further, the AC adapter 30 includes the AC power measurement circuit 301 (the example of the power status detection unit) for detecting AC power status, and the PD controller 309 (the example of the power information control unit) for transmitting, to the information processing apparatus 10, power information (for example, output power information) based on the detection result by the AC power measurement circuit 301.

Thus, since the AC adapter 30 notifies the information processing apparatus 10 of the power information (for example, the output power information) based on the detection result of the AC power status, the information processing apparatus 10 can control power consumption based on the notified power information. Therefore, the AC adapter 30 can properly detect whether or not the information processing apparatus 10 is being used in the location where the power supply is unstable to operate the information processing apparatus 10 stably.

Further, a control method in the information processing system 1 including the information processing apparatus 10 and the AC adapter 30 (the example of the power supply device) for supplying DC power converted from AC power to the information processing apparatus 10 according to one or more embodiments includes: a step of causing the AC adapter 30 to convert the AC power to the DC power and output the DC power; a step of causing the AC adapter 30 to detect AC power status; and a step of causing the AC adapter 30 to transmit, to the information processing apparatus 10, power information (for example, output power information) based on the detection result of the AC power status. Further, the control method in the information processing system 1 includes: a step of causing the information processing apparatus 10 to generate power to be consumed by loads within the information processing apparatus 10 based on the DC power supplied from the AC adapter; a step of causing the information processing apparatus 10 to acquire the power information (for example, the output power information) transmitted from the AC adapter 30; and a step of causing the information processing apparatus 10 to control power to be consumed by the loads within the information processing apparatus 10 based on the acquired power information (for example, the acquired output power information).

Thus, since the control method in the information processing system 1 is such that the AC adapter 30 notifies the information processing apparatus 10 of the power information based on the detection result of the AC power status, and the information processing apparatus 10 controls the power to be consumed by the loads within the information processing apparatus 10 based on the power information notified from the AC adapter 30, it can be properly detected whether or not the information processing apparatus 10 is being used in a location where the power supply is unstable to operate the information processing apparatus 10 stably.

Further, a control method in the AC adapter 30 (the example of the power supply device) according to one or more embodiments includes: a step of causing the above power supply unit to convert the AC power to the DC power and to output the DC power; a step of causing the AC power measurement circuit 301 (the example of the power status detection unit) to detect the AC power status; and a step of causing the PD controller 309 (the example of the power information control unit) to transmit, to the information processing apparatus 10, the power information (for example, the output power information) based on the detection result by the AC power measurement circuit 301.

Thus, since the control method in the AC adapter 30 notifies the information processing apparatus 10 of the power information (for example, the output power information) based on the detection result of the AC power status, the information processing apparatus 10 can control power consumption based on the notified power information. Therefore, the control method in the AC adapter 30 can properly detect whether or not the information processing apparatus 10 is being used in the location where the power supply is unstable to operate the information processing apparatus 10 stably.

Thus, according to one or more embodiments, the AC adapter 30 detects whether or not the information processing apparatus 10 is being used in a location where an AC power supply is unstable like inside an airplane, and notifies the information processing apparatus 10 of suppliable output power information. Therefore, the information processing apparatus 10 can be operated stably by an existing function of operating information processing apparatus 10 according to the power suppliable from the AC adapter 30 depending on the output power information of the AC adapter 30. In other words, according to one or more embodiments, the information processing apparatus 10 can be operated stably even when being used in a location where the power supply is unstable without adding a special function to the side of the information processing apparatus 10. Therefore, one or more embodiments can be applied to many common information processing apparatuses, and both of stable operation and ease of use for the user can be balanced.

### Second Embodiment

Next, a second embodiment of the present invention will be described.

In the first embodiment, the AC adapter 30 detects the AC power status, changes output power information (PDO) on output power suppliable from the AC adapter 30 based on the detection result, and notifies the information processing apparatus 10 of the changed output power information. In contrast to this, when the AC power becomes unstable, a notification to that effect may be given by the AC adapter 30 to the information processing apparatus 10, and the information processing apparatus 10 may perform control to change the maximum value of power consumption in response to receiving the notification. The maximum value of the output power is changed on the side of the AC adapter 30 in the first embodiment, while an example of changing the maximum value of power consumption on the side of the information processing apparatus 10 will be described in this embodiment.

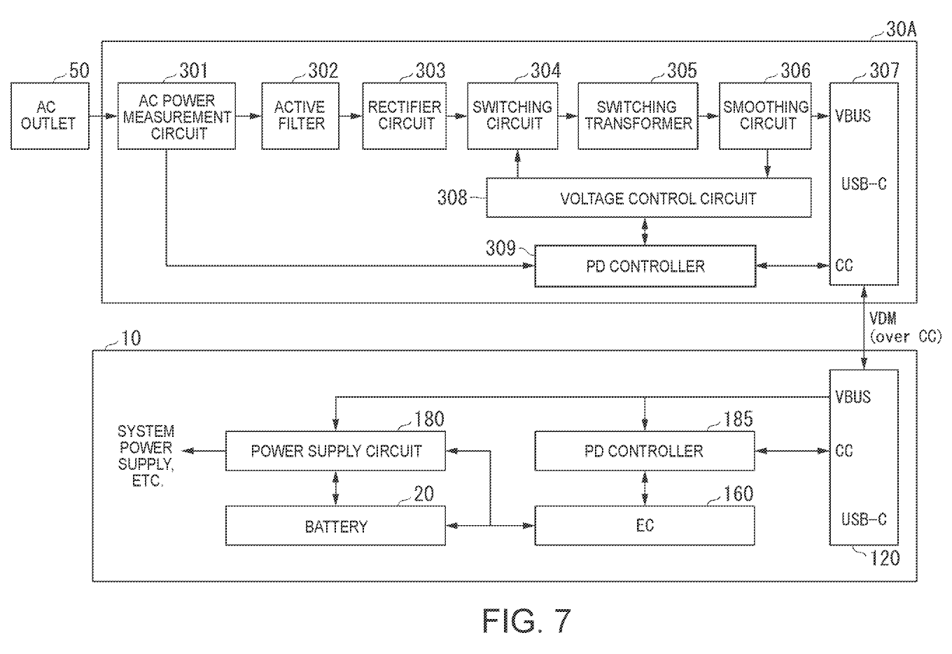

Referring to FIG. 7, the configuration of the information processing apparatus 10 and an AC adapter 30A, in which control to change the maximum value of power consumption is performed on the side of the information processing apparatus 10 depending on the AC power status in one or more embodiments will be described. FIG. 7 is a schematic block diagram illustrating an example of the configuration of the information processing apparatus 10 and the AC adapter 30A according to one or more embodiments.

The basic configuration of the information processing apparatus 10 according to one or more embodiments is the same as the configuration of the information processing apparatus 10 according to the first embodiment illustrated in FIG. 3, and part of the configuration is illustrated in FIG. 7. In FIG. 7, the same reference numerals are given to components corresponding to the respective units in FIG. 3.

Further, the configuration of the AC adapter 30A according to one or more embodiments is different from the configuration of the AC adapter 30 according to the first embodiment illustrated in FIG. 4 only in that any backup battery is unnecessary. Here, among processes performed in respective units of the information processing apparatus 10 and the AC adapter 30A, only points different from those in the first embodiment will be described.

When acquiring information indicative of the detection result of the AC power status from the AC power measurement circuit 301, and determining that the AC power becomes unstable based on the detection result, the PD controller 309 transmits, to the information processing apparatus 10, information for calling attention to the information processing apparatus 10 (hereinafter called “power attention information”). For example, when determining that the AC power becomes unstable (for example, that the voltage drops to a certain value) based on the detection result of a voltage fluctuation of the AC power by the AC power measurement circuit 301, the PD controller 309 transmits the power attention information to the information processing apparatus 10.

Upon transmitting the power attention information from the PD controller 309 to the information processing apparatus 10, for example, this “power attention information” is defined in a VDM (Vendor Defined Message) transmitted by a USB CC signal. Using the VDM of the USB CC signal, the PD controller 309 transmits the power attention information to the PD controller 185 of the information processing apparatus 10.

When acquiring the power attention information transmitted from the AC adapter 30A, the PD controller 185 delivers the acquired power attention information to the EC 160. The EC 160 controls the upper limit of power to be consumed by the loads within the information processing apparatus 10 based on the power attention information transmitted from the AC adapter 30A. Thus, when the AC power becomes unstable, the information processing apparatus 10 can be operated stably by reducing power consumption.

Next, the operation of power control processing in which, when the AC power becomes unstable in one or more embodiments, a notification to that effect is given from the AC adapter 30A to the information processing apparatus 10, and the information processing apparatus 10 performs control to change the maximum value of power consumption in response to receiving the notification will be described.

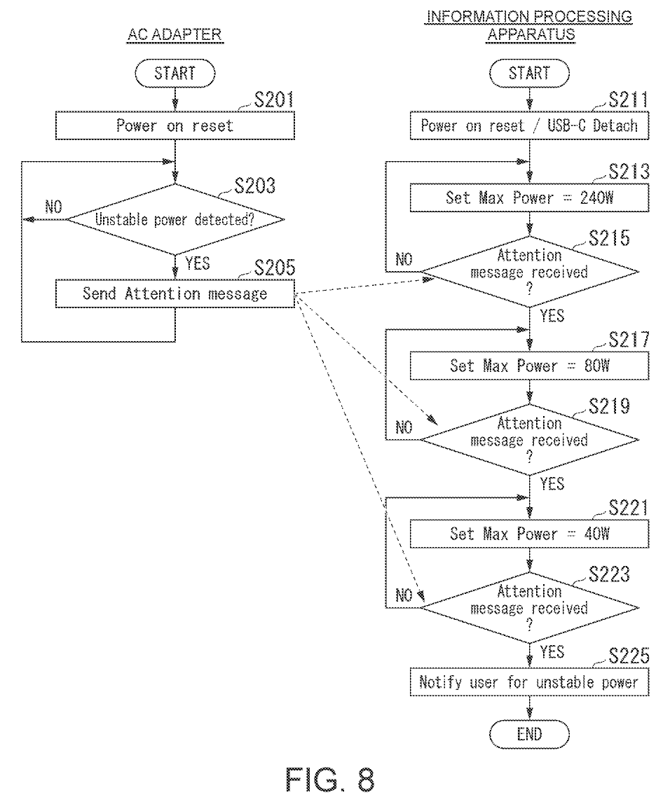

FIG. 8 is a flowchart illustrating an example of power control processing according to one or more embodiments.

First, the operation of processing of the AC adapter 30A will be described.

(Step S201) The supply of AC power from the AC outlet 50 to the AC adapter 30A is started and the circuits in the AC adapter 30A are reset (Power on reset). Then, the procedure proceeds to a process in step S203.

(Step S203) The PD controller 309 acquires the detection result of the AC power status from the AC power measurement circuit 301, and determines whether or not the AC power becomes unstable based on the acquired detection result. For example, the PD controller 309 determines whether or not the AC power becomes unstable, for example, depending on whether or not the voltage drops to the certain value based on the detection result of the voltage fluctuation of the AC power. When determining that the AC power is stable (NO), the PD controller 309 performs the process in step S203 again without proceeding to a process in step S205. On the other hand, when determining that the AC power is unstable, that is, unstable AC power is detected (YES), the PD controller 309 proceeds to the process in step S205.

(Step S205) Using the VDM of the USB CC signal, the PD controller 309 transmits the power attention information (Attention message) to the PD controller 185 of the information processing apparatus 10. Then, the PD controller 309 returns to the process in step S203.

Next, the operation of processing of the information processing apparatus 10 will be described.

(Step S211) When being reset by powering on (Power on reset) or when the disconnection with the AC adapter 30A has occurred (the connection is cut off) by detaching the USB-C connector 32, the EC 160 proceeds to a process in step S213. Note that when the connection between the information processing apparatus 10 and AC adapter 30A is lost (cut off), it is assumed here that the information processing apparatus 10 and AC adapter 30A are connected again (the USB-C connector 32 is attached again).

(Step S213) The EC 160 sets output power suppliable from the AC adapter 30A to the initial value (for example, 240 W) (Set Max power = 240 W), and controls power to be consumed by the loads within the information processing apparatus 10 using the set output power as the upper limit. Then, the EC 160 proceeds to a process in step S215.

(Step S215) The EC 160 determines whether or not power attention information (Attention message) is received from the AC adapter 30A through the PD controller 185. When determining that no power attention information is received (NO), the EC 160 returns to the process in step S213. On the other hand, when determining that the power attention information is received (YES), the EC 160 proceeds to a process in step S217.

(Step S217) The EC 160 changes the output power suppliable from the AC adapter 30A to a value smaller than the initial value (for example, 80 W) (Set Max power = 80 W), and controls power to be consumed by the loads within the information processing apparatus 10 using the changed output power value as the upper limit. Then, the EC 160 proceeds to a process in step S219.

(Step S219) The EC 160 determines whether or not power attention information (Attention message) is received from the AC adapter 30A through the PD controller 185. When determining that no power attention information is received (NO), the EC 160 returns to the process in step S217. On the other hand, when determining that the attention information is received (YES), the EC 160 proceeds to a process in step S221.

(Step S221) The EC 160 changes the output power suppliable from the AC adapter 30A to a further smaller value (for example, 40 W) (Set Max power = 40 W), and controls power to be consumed by the loads within the information processing apparatus 10 using the changed output power as the upper limit. Then, the EC 160 proceeds to a process in step S223.

(Step S223) The EC 160 determines whether or not power attention information (Attention message) is received from the AC adapter 30A through the PD controller 185. When determining that no power attention information is received (NO), the EC 160 returns to the process in step S221. On the other hand, when determining that the attention information is received (YES), the EC 160 proceeds to a process in step S225.

(Step S225) The EC 160 notifies the user that the power supplied from the AC adapter 30A is unstable. As the notification method, any method can be applied. For example, the notification may be done in a way that the EC 160 notifies the system processing unit 170 that the power is unstable to display, on the display unit 110, that the power is unstable by processing in the system processing unit 170. In short, this state in step S225 means that the environment is not suitable for using the information processing apparatus 10.

As described above, in one or more embodiments, it is determined in the AC adapter 30A (another example of the power supply device) that the AC power becomes unstable based on the detection result by the AC power measurement circuit 301 (the example of the power status detection unit), the PD controller 309 (the example of the power information control unit) transmits power information (for example, power attention information) to the information processing apparatus 10.

Thus, since a notification of the power information (for example, the power attention information) is given from the AC adapter 30A to the information processing apparatus 10 when the AC power becomes unstable, the information processing apparatus 10 to which the power information (for example, the power attention information) is notified can be operated stably by reduce power consumption.

For example, in the AC adapter 30A, the AC power measurement circuit 301 detects a voltage fluctuation of the AC power. Then, when determining that the AC power becomes unstable based on the detection result of the voltage fluctuation of the AC power by the AC power measurement circuit 301, the PD controller 309 transmits the power information (for example, the power attention information) to the information processing apparatus 10.

Thus, since the notification of the power information (for example, the power attention information) is given from the AC adapter 30A to the information processing apparatus 10 when the voltage fluctuation occurs to make the AC power unstable, the information processing apparatus 10 to which the power information (for example, the power attention information) is notified can be operated stably by reducing power consumption.

Further, in the information processing apparatus 10, the EC 160 (the example of the control unit) controls the upper limit of power to be consumed by the loads within the information processing apparatus 10 based on the power information (for example, the power attention information) transmitted from the AC adapter 30A.

Thus, since the information processing apparatus 10 sets the upper limit of power consumption based on the power information (for example, the power attention information) transmitted from the AC adapter 30A, the information processing apparatus 10 can be operated stably.

Further, the AC adapter 30A (the example of the power supply device) according to one or more embodiments supplies, to the information processing apparatus 10, DC power converted from AC power. The AC adapter 30A includes the power supply unit for converting the AC power to the DC power and outputting the DC power (for example, the active filter 302, the rectifier circuit 303, the switching circuit 304, the switching transformer 305, the smoothing circuit 306, the USB-C interface 307, and the voltage control circuit 308). Further, the AC adapter 30A includes the AC power measurement circuit 301 for detecting AC power status (the example of power status detection unit), and the PD controller 309 (the example of the power information control unit) for transmitting, to the information processing apparatus 10, power information (for example, power attention information) based on a determination result when it is determined that the AC power becomes unstable based on the detection result by the AC power measurement circuit 301.

Thus, since the AC adapter 30A notifies the information processing apparatus 10 of the power information (for example, the power attention information) when the AC power becomes unstable, the information processing apparatus 10 to which the power information (for example, the power attention information) is notified can be operated stably by reducing power consumption.

Further, the information processing apparatus 10 according to one or more embodiments receives, from the AC adapter 30A (the example of the power supply device), the supply of DC power converted from AC power. The information processing apparatus 10 includes the power supply circuit 180 (the example of the power supply unit) for generating power to be consumed by the loads within the information processing apparatus 10 based on the DC power supplied from the AC adapter 30A, and the EC 160 (the example of the control unit) for acquiring, from the AC adapter 30A, power information (for example, power attention information) based on the detection result of the AC power status to control the upper limit of power to be consumed by the loads within the information processing apparatus 10 based on the acquired power information.

Thus, since the information processing apparatus 10 sets the upper limit of power consumption in response to acquiring, from the AC adapter 30A, the power information (for example, the power attention information) based on the detection result of the AC power status, the information processing apparatus 10 can be operated stably.

Further, a control method in the AC adapter 30A (the example of the power supply device) according to one or more embodiments includes: a step of causing the power supply unit to convert AC power to DC power and to output the DC power; a step of causing the AC power measurement circuit 301 (the example of the power status detection unit) to detect AC power status; and a step of causing the PD controller 309 (the example of the power information control unit) to transmit, to the information processing apparatus 10, power information (for example, power attention information) based on a determination result when it is determined that the AC power becomes unstable based on the detection result by the AC power measurement circuit 301.

Thus, since the control method in the AC adapter 30A notifies the information processing apparatus 10 of the power information (for example, the power attention information) when the AC power becomes unstable, the information processing apparatus 10 to which the power information (for example, the power attention information) is notified can be operated stably by reducing power consumption.

Further, a control method in the information processing apparatus 10 according to one or more embodiments includes: a step of causing the power supply circuit 180 (the example of the power supply unit) to generate power to be consumed by the loads within the information processing apparatus 10 based on DC power supplied from the AC adapter 30A; a step of causing the EC 160 (the example of the control unit) to acquire, from the AC adapter 30A, power information (for example, power attention information) based on the detection result of AC power status; and a step of causing the EC 160 to control the upper limit of power to be consumed by the loads within the information processing apparatus 10 based on the acquired power information.

Thus, since the control method in the information processing apparatus 10 sets the upper limit of power consumption in response to acquiring, from the AC adapter 30A, the power information (for example, the power attention information) based on the detection result of the AC power status to operate the information processing apparatus 10, the information processing apparatus 10 can be operated stably.

Thus, according to one or more embodiments, when the AC power becomes unstable, a notification is sent from the AC adapter 30A to the information processing apparatus 10 without the need for the backup power supply 310 included in the AC adapter 30 in one or more embodiments. Therefore, the information processing apparatus 10 can be operated stably by reducing power consumption on the side of the information processing apparatus 10 using the notification as a trigger, and leading to AC power disconnection (cutoff) can be prevented.

While embodiments of this invention have been described in detail with reference to the accompanying drawings, the specific configurations are not limited to those in the above-described embodiments, design changes and the like without departing from the scope of this invention are included. For example, the respective configurations described in the above-described embodiments can be combined arbitrarily.

Note that, in the aforementioned embodiments, the example in which the AC adapter 30 (30A) is connected to the information processing apparatus 10 through the USB connector 120 (USB-C connector) is described, but the connection method is not limited to this example.

Further, each of the values of output power of the AC adapter 30 (30A) (for example, 240 W, 80 W, or 40 W) exemplified in the aforementioned embodiments is just an example, and the value can be set to any value.

Note that the information processing apparatus 10 described above has a computer system therein. Then, a program for implementing the function of each component included in the information processing apparatus 10 described above may be recorded on a computer-readable recording medium so that the program recorded on this recording medium is read into the computer system and executed to perform processing in each component included in the information processing apparatus 10 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 10, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the respective functions of the information processing apparatus 10 in the embodiments described above may be realized as an integrated circuit such as LSI (Large Scale Integration). Each function may be implemented as a processor individually, or some or all of the functions may be integrated as a processor. Further, the method of circuit integration is not limited to LSI, and may be realized by a dedicated circuit or a general-purpose processor. Further, if integrated circuit technology replacing the LSI appears with the progress of semiconductor technology, an integrated circuit according to the technology may be used.

### Description of Symbols

10 information processing apparatus

20 battery

30, 30A AC adapter

110 display unit

120 USB connector

130 input device

131 keyboard

133 touchpad

140 communication unit

150 storage unit

160 EC

170 system processing unit

171 CPU

172 GPU

173 memory controller

174 I/O controller

175 system memory

180 power supply circuit

185 PD controller

301 AC power measurement circuit

302 active filter

303 rectifier circuit

304 switching circuit

305 switching transformer

306 smoothing circuit

307 USB-C interface

308 voltage control circuit

309 PD controller

310 backup power supply

What is claimed is:

1. An information processing system comprises:
an information processing apparatus and a power supply device to supply, to the information processing apparatus, DC power converted from AC power, wherein
the power supply device comprises:
a power supply unit which converts the AC power to the DC power and outputs the DC power;
a power status detection unit which detects a status of the AC power; and
a power information control unit which transmits, to the information processing apparatus, power information based on the detection result by the power status detection unit, and
the information processing apparatus comprises:
a power supply unit which generates power to be consumed by loads within the information processing apparatus based on the DC power supplied from the power supply device; and
a control unit which controls the power to be consumed by the loads within the information processing apparatus based on the power information transmitted from the power supply device.

2. The information processing system according to claim 1, wherein in the power supply device, the power information control unit transmits, to the information processing apparatus, information indicative of suppliable power as the power information based on the detection result by the power status detection unit.

3. The information processing system according to claim 2, wherein in the power supply device,
the power status detection unit detects a voltage fluctuation of the AC power, and
the power information control unit changes the suppliable power from an initial value based on the detection result of the voltage fluctuation of the AC power by the power status detection unit.

4. The information processing system according to claim 2, wherein in the power supply device,
the power status detection unit detects a frequency of the AC power, and
the power information control unit changes the suppliable power from an initial value based on the detection result of the frequency of the AC power by the power status detection unit.

5. The information processing system according to claim 3, wherein in the power supply device, the power information control unit sets the suppliable power to the initial value when connection between the power supply device and the information processing apparatus is cut off.

6. The information processing system according to claim 2, wherein in the information processing apparatus, the control unit controls the power to be consumed by the loads within the information processing apparatus using, as an upper limit, the suppliable power indicated in the power information transmitted from the power supply device.

7. The information processing system according to claim 2, wherein the power supply device further comprises
a backup power supply which supplies power, as a substitute, when power cannot be supplied to the power status detection unit and the power information control unit due to the voltage fluctuation of the AC power.

8. The information processing system according to claim 1, wherein in the power supply device, when it is determined that the AC power becomes unstable based on the detection result by the power status detection unit, the power information control unit transmits the power information to the information processing apparatus.

9. The information processing system according to claim 8, wherein in the power supply device,
the power status detection unit detects a voltage fluctuation of the AC power, and
when it is determined that the AC power becomes unstable based on the detection result of the voltage fluctuation of the AC power by the power status detection unit, the power information control unit transmits the power information to the information processing apparatus.

10. The information processing system according to claim 8, wherein in the information processing apparatus, the control unit controls an upper limit of power to be consumed by the loads within the information processing apparatus based on the power information transmitted from the power supply device.

11. A power supply device, which supplies, to an information processing apparatus, DC power converted from AC power, comprising:
a power supply unit which converts the AC power to the DC power and outputs the DC power;
a power status detection unit which detects a status of the AC power; and
a power information control unit which transmits, to the information processing apparatus, power information indicative of suppliable power based on the detection result by the power status detection unit.

12. A power supply device, which supplies, to an information processing apparatus, DC power converted from AC power, comprising:
a power supply unit which converts the AC power to the DC power and outputs the DC power;
a power status detection unit which detects a status of the AC power; and
a power information control unit which transmits, to the information processing apparatus, power information based on a determination result when it is determined that the AC power becomes unstable based on the detection result by the power status detection unit.

13. An information processing apparatus, which receives, from a power supply device, supply of DC power converted from AC power, comprising:
a power supply unit which generates power to be consumed by loads within the information processing apparatus based on the DC power supplied from the power supply device; and
a control unit which acquires, from the power supply device, power information based on a detection result of a status of the AC power, and controls an upper limit of the power to be consumed by the loads within the information processing apparatus based on the acquired power information.

14. A control method in an information processing system including an information processing apparatus and a power supply device to supply, to the information processing apparatus, DC power converted from AC power, the control method comprising:
a step of causing the power supply device to convert the AC power to the DC power and to output the DC power;
a step of causing the power supply device to detect a status of the AC power;
a step of causing the power supply device to transmit, to the information processing apparatus, power information based on the detection result of the status of the AC power;
a step of causing the information processing apparatus to generate power to be consumed by loads within the information processing apparatus based on the DC power supplied from the power supply device;
a step of causing the information processing apparatus to acquire the power information transmitted from the power supply device; and
a step of causing the information processing apparatus to control the power to be consumed by the loads within the information processing apparatus based on the acquired power information.

15. A control method in a power supply device which supplies, to an information processing apparatus, DC power converted from AC power, the control method comprising:
a step of causing a power supply unit to convert the AC power to the DC power and to output the DC power;
a step of causing a power status detection unit to detect a status of the AC power; and
a step of causing a power information control unit to transmit, to the information processing apparatus, power information indicative of suppliable power based on the detection result by the power status detection unit.

16. A control method in a power supply device which supplies, to an information processing apparatus, DC power converted from AC power, the control method comprising:
a step of causing a power supply unit to convert the AC power to the DC power and to output the DC power;
a step of causing a power status detection unit to detect a status of the AC power; and
a step in which, when it is determined that the AC power becomes unstable based on the detection result by the power status detection unit, a power information control unit transmits, to the information processing apparatus, power information based on the determination result.

17. A control method in an information processing apparatus which receives, from a power supply device, supply of DC power converted from AC power, the control method comprising:
a step of causing a power supply unit to generate power to be consumed by loads within the information processing apparatus based on the DC power supplied from the power supply device;
a step of causing a control unit to acquire, from the power supply device, power information based on a detection result of a status of the AC power; and
a step of causing the control unit to control an upper limit of the power to be consumed by the loads within the information processing apparatus based on the acquired power information.
